(19) United States
(12) Patent Application Publication
(10) Pub. No.: US 2021/0163663 A1
(43) Pub. Date: Jun. 3, 2021

(54) PROCESS FOR PRODUCING POLYURETHANE/POLYISOCYANURATE (PUR/PIR) RIGID FOAMS

(71) Applicant: Covestro Intellectual Property GmbH & Co. KG, Leverrkusen (DE)

(72) Inventors: Nicole Welsch, Köln (DE); Ralf Koester, Leverkusen (DE); Rene Abels, Köln (DE); Inge Tinnefeld, Köln (DE)

(21) Appl. No.: 17/045,265

(22) PCT Filed: Apr. 9, 2019
(86) PCT No.: PCT/EP2019/058874

§ 371 Date: Oct. 5, 2020

(30) Foreign Application Priority Data
Apr. 13, 2018 (EP) 18167400.3

(51) Int. Cl. C08G 18/42; C08G 18/18; C08G 18/76; C08J 9/14; C08K 5/00

(52) U.S. Cl. CPC C08G 18/4238; C08G 18/1816; C08G 18/7664; C08G 2110/0075; C08K 5/0066; C08G 2110/0025; C08J 9/148

(57) ABSTRACT

The invention relates to a process for producing polyurethane/polyisocyanurate rigid foams by reacting a specific reaction mixture in the presence of a catalyst component containing potassium formate and an amine, and to the polyurethane/polyisocyanurate rigid foams produced according to said method.

The invention relates to a process for producing rigid polyurethane/polyisocyanurate (PUR/PIR) foams comprising the step of i) reacting a reaction mixture containing

A) a polyisocyanate component and

B) an isocyanate-reactive component comprising
B1) a polyol component,
B2) a catalyst component,
B3) optionally auxiliary and additive substances and

C) a physical blowing agent

characterized

in that the catalyst component B2) contains potassium formate B2.a) and an amine B2.b), and

in that the reaction mixture contains less than 0.2% by weight of formic acid and has an isocyanate index ≥150,

and with the proviso that the reaction mixture reacted in step i) contains no aminic compounds having the formula (I)

R¹N(CH₃)(CH₂CH₂OR²) (I)
wherein R¹ represents CH₃, CH₂—CH₂—N(CH₃)₂ or CH₂—CH₂OH, and
   R² represents H, CH₂—CH₂OH or CH₂—CH₂N(CH₃)₂,

Rigid polyurethane/polyisocyanurate (PUR/PIR) foams are known. The production thereof is typically carried out by reaction of an excess of polyisocyanates with compounds having isocyanate-reactive hydrogen atoms, in particular polyols. The isocyanate excess, generally with an isocyanate index of at least 150 or more, has the result that in addition to urethane structures, formed by reaction of isocyanates with compounds having reactive hydrogen atoms, other structures are formed by reaction of the isocyanate groups with one another or with other groups, for example polyurethane groups.

Rigid PUR/PIR foams have desirable properties in respect of thermal insulation and fire behavior. This applies especially to polyester-based rigid PUR/PIR foams (i.e. rigid PUR/PIR foams which, based on the total weight of the isocyanate-reactive components, were produced comprising >40% by weight, in particular >50% by weight, very particularly >55% by weight, of polyester polyols or polyether ester polyols). On account of these properties said foams are used for insulating composite elements, for example metal sandwich elements, for use in industrial buildings construction for example. Composite elements are especially used for construction of refrigerated warehouses.

In order to be able to achieve the desired foam properties, for example apparent densities and thermal insulation properties of the rigid PUR/PIR foams, physical blowing agents are added to the reaction mixture. Hydrocarbons have advantages such as an advantageous effect on the lambda value but are also associated with disadvantages, especially their highly flammable nature.

One goal in the production of hydrocarbon-blown rigid PUR/PIR foams is therefore to keep the amount of employed flammable hydrocarbons as low as possible without negatively affecting further properties associated with the blowing agent, such as foam pressure, dimensional stability, density and shrinkage.

Composite elements used for construction of refrigerated warehouses are often exposed to permanently low temperatures in the range from 0° C. to −30° C. However, it has been found that composite elements shrink in thickness if permanently used under these conditions. This shrinkage then results inter alia in undesired stresses in the buildings erected with the composite elements and in misalignment between individual composite elements and associated defects in appearance.

The PUR/PIR reaction mixture is generally admixed with catalyst components suitable for catalyzing the blowing reaction, the urethane reaction and/or the isocyanurate reaction (trimerization) Amine-based catalyst systems are often used for both reactions and the use of potassium salts, in particular potassium acetate, as a trimerization catalyst is also known.

The use of alkali metal or alkaline earth metal formates in water or formic acid-blown polyurethane foams having an index up to 130 is known. For example, U.S. Pat. No. 5,286,758 A describes the use of a combination of potassium formate and dimethylcyclohexylamine in water-catalyzed foams which brings about a marked reactivity increase but also scorching in the foam.

WO 07/25888 A describes the use of a catalyst system consisting of certain aminoethyl ethers or aminoethyl alcohols and also salts of aromatic or aliphatic carboxylic acids, including potassium formate, in PUR/PIR systems. When using such catalyst systems a positive effect on the surface is observed for formic acid/water-blown PUR/PIR foams. WO 07/25888 describes, and also demonstrates in the experiments, that using formic acid as the blowing agent results in PUR/PIR foams having long curing times. The solution proposed by WO 07/25888 is the use of the abovementioned catalyst system. When using this catalyst system better curing times are achieved with formic acid (ibid, table 2) than when the aminoethyl ether is eschewed (and replaced by an aliphatically substituted tertiary amine). If, by contrast, the use of formic acid is eschewed and these are replaced by a water/dipropylene glycol mixture a markedly poorer foam (brittle, increased number of surface defects) is obtained. WO 07/25888 altogether discloses good results only for the use of formic acid in combination with the catalyst system potassium formate/aminoethyl ether.

U.S. Pat. No. 4 277 571 A describes the production of potassium formate-catalyzed polyisocyanurate foams on the basis of a polyhydroxy compound which contains naphthenic acids or derivatives thereof and a hydroxy-functional amine. The foams are said to have good physical properties, especially compression and dimensional stability.

However, it is also known that the use of naphthenic acids in general and/or formic acid as blowing agents can lead to corrosion problems in the plant and that there is the risk of carbon monoxide formation (see, for example, “Reactive Polymers Fundamentals and Applications”, 2nd Edition, 2013, Johannes Karl Fink, ISBN: 978-1-4557-3149-7). The use of formic acid leads to increased urea formation, which in turn increases brittleness and negatively affects adhesion to the top layers compared to purely physically-blown foams.

WO 2012/126916 A describes the use of carboxylic acid salts, including potassium formate, as catalysts in polyether-based polyurethane foams contain a special mixture of at least two polyether polyols and a polyester polyol in an index range of 140 to 180. This is said to achieve advantageous thermal conductivity characteristics.

Proceeding from the described prior art the present application has for its object to provide a process for producing rigid PUR/PIR foams containing physical blowing agents which improves the known PUR/PIR systems in respect of foam pressure and curing without requiring the use of greater amounts of the physical blowing agent while simultaneously also very largely or even completely eschewing the use of formic acid as blowing agents.

The recited object was able, surprisingly, now to be achieved by a process for producing a rigid PUR/PIR foam comprising the step of i) reacting a reaction mixture containing

A) a polyisocyanate component

B) an isocyanate-reactive component comprising
B1) a polyol component,
B2) a catalyst component,
B3) optionally auxiliary and additive substances,

C) a physical blowing agent

characterized

the catalyst component B2) contains potassium formate B2.a) and an amine B2.b) and

in that the reaction mixture contains less than 0.2% by weight of formic acid and has an isocyanate index ≥150,

and with the proviso that the reaction mixture reacted in step i) contains no aminic compounds having the formula (I).

The reaction mixture preferably further contains no naphthenic acids or only small amounts of naphthenic acids. In a particularly preferred embodiment the reaction mixture contains less than 0.2% by weight of naphthenic acids (preferably less than 0.1% by weight of naphthenic acids, especially preferably no naphthenic acids).

In further very preferred embodiments the reaction mixture contains no naphthenic acids and less than 0.2% by weight of formic acid (in particular less than 0.1% by weight of formic acid, very particularly preferably no formic acid).

The isocyanate-reactive component contains a polyol component B1) comprising at least one polyol selected from the group consisting of polyester polyols, polyether polyols, polyester polyols, polycarbonate polyols, polyether polycarbonate polyols and polyether ester polyols.

In a preferred embodiment, the isocyanate-reactive component B) comprises a polyol component B1) comprising

B1.a) at least one polyol selected from the group consisting of polyester polyols and polyether ester polyols

B1.b) optionally further polyols selected from the group consisting of polyether polyols, polycarbonate polyols and polyether polycarbonate polyols and

B1.c) optionally further isocyanate-reactive components.

The polyol component B1.a) is one or more polyols selected from the group consisting of polyester polyols and polyether ester polyols.

Based on the total weight of component B1) the proportion of polyol component B1.a) is preferably at least 40% by weight and preferably at least 50% by weight, particularly preferably at least 55% by weight, very particularly preferably at least 60% by weight. In a preferred embodiment the proportion of polyester polyol B1.a) in the component B1) is 65-98% by weight.

Suitable polyester polyols are inter alia polycondensates of di- and also tri- and tetraols and di- and also tri- and tetracarboxylic acids or hydroxycarboxylic acids or lactones. Also employable for producing the polyesters instead of the free polycarboxylic acids are the corresponding polycarboxylic anhydrides or corresponding polycarboxylic esters of lower alcohols.

Examples of suitable diols are ethylene glycol, butylene glycol, diethylene glycol, triethylene glycol, polyalkylene glycols such as polyethylene glycols and also 1,2-propanediol, 1,3-propanediol, 1,3-butanediol, 1,4-butanediol, 1,6-hexanediol and isomers, neopentyl glycol or neopentyl glycol hydroxypivalate. Also employable in addition are polyols such as trimethylolpropane, glycerol, erythritol, pentaerythritol, trimethylolbenzene or trishydroxyethyl isocyanurate. In addition, monohydric alkanols can also be co-used.

Examples of polycarboxylic acids that may be used include phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, succinic acid, 2-methylsuccinic acid, 3,3-diethylglutaric acid, 2,2-dimethylsuccinic acid, dodecanedioic acid, endomethylenetetrahydrophthalic acid, dimer fatty acid, trimer fatty acid, citric acid, or trimellitic acid. In certain embodiments the use of polyesters containing aliphatic dicarboxylic acids (for example glutaric acid, adipic acid, succinic acid) is preferred, especially the use of purely aliphatic polyesters (without aromatic groups). It is also possible to use the corresponding anhydrides as the acid source. Additional co-use of monocarboxylic acids such as benzoic acid and alkanecarboxylic acids is also possible.

Hydroxycarboxylic acids that may be co-employed as reaction participants in the production of a polyester polyol having terminal hydroxyl groups are for example hydroxycaproic acid, hydroxybutyric acid, hydroxydecanoic acid, hydroxystearic acid and the like. Suitable lactones include caprolactone, butyrolactone and homologs.

Suitable compounds for producing the polyester polyols also include in particular bio-based starting materials and/or derivatives thereof, for example castor oil, polyhydroxy fatty acids, ricinoleic acid, hydroxyl-modified oils, grapeseed oil, black cumin oil, pumpkin kernel oil, borage seed oil, soybean oil, wheat germ oil, rapeseed oil, sunflower kernel oil, peanut oil, apricot kernel oil, pistachio oil, almond oil, olive oil, macadamia nut oil, avocado oil, sea buckthorn oil, sesame oil, hemp oil, hazelnut oil, primula oil, wild rose oil, safflower oil, walnut oil, fatty acids, hydroxyl-modified and epoxidized fatty acids and fatty acid esters, for example based on myristoleic acid, palmitoleic acid, oleic acid, vaccenic acid, petroselic acid, gadoleic acid, erucic acid, nervonic acid, linoleic acid, alpha- and gamma-linolenic acid, stearidonic acid, arachidonic acid, timnodonic acid, clupanodonic acid and cervonic acid. Esters of ricinoleic acid with polyfunctional alcohols, for example glycerol, are especially preferred. Preference is also given to the use of mixtures of such bio-based acids with other carboxylic acids, for example phthalic acids.

The polyester polyols preferably have an acid number of 0-5 mg KOH/g. This ensures that blocking of aminic catalysts by conversion into ammonium salts takes place only to a limited extent and the reaction kinetics of the foaming reaction are impaired only to a small extent.

Usable polyether ester polyols are those compounds containing ether groups, ester groups and OH groups. Organic dicarboxylic acids having up to 12 carbon atoms are suitable for producing the polyether ester polyols, preferably aliphatic dicarboxylic acids having ≥4 to ≤6 carbon atoms or aromatic dicarboxylic acids used individually or in a mixture. Examples include suberic acid, azelaic acid, decanedicarboxylic acid, maleic acid, malonic acid, phthalic acid, pimelic acid and sebacic acid and in particular glutaric acid, fumaric acid, succinic acid, adipic acid, phthalic acid, terephthalic acid and isoterephthalic acid. Also employable in addition to organic dicarboxylic acids are derivatives of these acids, for example their anhydrides and also their esters and monoesters with low molecular weight monofunctional alcohols having ≥1 to ≤4 carbon atoms. The use of proportions of the abovementioned bio-based starting materials, in particular of fatty acids/fatty acid derivatives (oleic acid, soybean oil etc.), is likewise possible and can have advantages, for example in respect of storage stability of the polyol formulation, dimensional stability, fire behavior and compressive strength of the foams.

Polyether polyols obtained by alkoxylation of starter molecules such as polyhydric alcohols are a further component used for producing the polyether ester polyols. The starter molecules are at least difunctional, but may optionally also contain proportions of higher-functional, in particular trifunctional, starter molecules.

Starter molecules include for example diols having number-average molecular weights Mn of preferably ≥18 g/mol to ≤400 g/mol, preferably of ≥62 g/mol to ≤200 g/mol, such as 1,2-ethanediol, 1,3-propanediol, 1,2-propanediol, 1,4-butanediol, 1,5-pentenediol, 1,5-pentanediol, neopentyl glycol, 1,6-hexanediol, 1,7-heptanediol, 1,8-octanediol, 1,10-decanediol, 2-methyl-1,3-propanediol, 2,2-dimethyl-1,3-propanediol, 3-methyl-1,5 -pentanediol, 2-butyl-2-ethyl-1,3-propanediol, 2-butene-1,4-diol and 2-butyne-1,4-diol, ether diols such as diethylene glycol, triethylene glycol, tetraethylene glycol, dibutylene glycol, tributylene glycol, tetrabutylene glycol, dihexylene glycol, trihexylene glycol, tetrahexylene glycol and oligomeric mixtures of alkylene glycols, such as diethylene glycol. Starter molecules having functionalities other than OH can also be used alone or in a mixture.

In addition to the diols compounds having >2 Zerewitinoff-active hydrogens, in particular having number-average functionalities of >2 to ≤8, in particular of ≥3 to ≤6, may also be co-used as starter molecules for producing the polyethers, for example 1,1,1-trimethylolpropane, triethanolamine, glycerol, sorbitan and pentaerythritol and also triol- or tetraol-started polyethylene oxide polyols having average molar masses Mn of preferably ≥62 g/mol to ≤400 g/mol, in particular of ≥92 g/mol to ≤200 g/mol.

Polyether ester polyols may also be produced by alkoxylation, in particular by ethoxylation and/or propoxylation, of reaction products obtained by the reaction of organic dicarboxylic acids and their derivatives and components with Zerewitinoff-active hydrogens, in particular diols and polyols. Derivatives of these acids that may be employed include for example their anhydrides, for example phthalic anhydride.

Processes for preparing the polyols have been described for example by Ionescu in “Chemistry and Technology of Polyols for Polyurethanes”, Rapra Technology Limited, Shawbury 2005, p. 55 ff.

(chapt. 4: Oligo-Polyols for Elastic Polyurethanes), p. 263 ff. (chapt. 8: Polyester Polyols for Elastic Polyurethanes) and in particular on p. 321 ff. (chapt. 13: Polyether Polyols for Rigid Polyurethane Foams) and p. 419 ff. (chapt. 16: Polyester Polyols for Rigid Polyurethane Foams). It is also possible to obtain polyester and polyether polyols by glycolysis of suitable polymer recyclates. Suitable polyether-polycarbonate polyols and the production thereof are described for example in EP 2910585 A, [0024]-[0041]. Examples relating to polycarbonate polyols and production thereof may be found inter alia in EP 1359177 A. Production of suitable polyether ester polyols is described inter alia in WO 2010/043624 A and in EP 1 923 417 A.

B1.a) preferably contains polyester polyols and/or polyether ester polyols which have functionalities of ≥1.2 to ≤3.5, in particular ≥1.6 to ≤2.4, and a hydroxyl number between 100 to 300 mg KOH/g, particularly preferably 150 to 270 mg KOH/g and especially preferably of 160-260 mg KOH/g. The polyester polyols and polyether ester polyols preferably have more than 70 mol %, preferably more than 80 mol %, in particular more than 90 mol %, of primary OH groups.

In the context of the present invention the number-average molar mass Mₙ (also known as molecular weight) is determined by gel permeation chromatography according to DIN 55672-1 of August 2007.

The “hydroxyl number” indicates the amount of potassium hydroxide in milligrams which is equivalent in an acetylation to the acetic acid quantity bound by one gram of substance. In the context of the present invention said number is determined according to the standard DIN 53240-2 (1998).

In the context of the present invention the “acid number” is determined according to the standard DIN EN ISO 2114:2002-06.

Within the context of the present invention, “functionality” refers to the theoretical average functionality (number of isocyanate-reactive or polyol-reactive functions in the molecule) calculated from the known feedstocks and quantitative ratios thereof.

In the context of the present application “a polyester polyol” may also be a mixture of different polyester polyols, wherein in this case the mixture of the polyester polyols in its entirety has the recited OH number. This applies analogously to the further herein-recited polyols and their indices.

Also employable in the isocyanate-reactive component B) in addition to the abovedescribed polyols of the polyol component B1.a) are further isocyanate-reactive components.

Especially employed therefor are further polyols B1.b) selected from the group containing polyether polyols, polycarbonate polyols and polyether carbonate polyols. It is very particularly preferable to also employ one or more polyether polyols in addition to the one or more polyols B1.a).

The addition of long-chain polyols, in particular polyether polyols, can bring about the improvement in the flowability of the reaction mixture and the emulsifiability of the blowing agent-containing formulation. For the production of composite elements these can allow continuous production of elements with flexible or rigid outerlayers.

These long-chain polyols have functionalities of ≥1.2 to ≤3.5 and have a hydroxyl number between 10 and 100 mg KOH/g, preferably between 20 and 50 mg KOH/g. They comprise more than 70 mol %, preferably more than 80 mol %, in particular more than 90 mol %, of primary OH groups. The long-chain polyols are preferably polyether polyols having functionalities of ≥1.2 to ≤3.5 and a hydroxyl number between 10 and 100 mg KOH/g.

The addition of medium-chain polyols, in particular polyether polyols, and low molecular weight isocyanate-reactive compounds can bring about the improvement in the adhesion and dimensional stability of the resulting foam. For the production of composite elements with the process according to the invention these medium-chain polyols can allow continuous production of elements with flexible or rigid outerlayers. The medium-chain polyols, which are in particular polyether polyols, have functionalities of ≥2 to ≤6 and have a hydroxyl number between 300 and 700 mg KOH/g.

The polyether polyols used are the polyether polyols employable in polyurethane synthesis, known to those skilled in the art and having the features mentioned.

Employable polyether polyols are for example polytetramethylene glycol polyethers such as are obtainable by polymerization of tetrahydrofuran by cationic ring opening.

Likewise suitable polyether polyols are addition products of styrene oxide, ethylene oxide, propylene oxide, butylene oxide and/or epichlorohydrin onto di- or polyfunctional starter molecules. The addition of ethylene oxide and propylene oxide is especially preferred. Suitable starter molecules are for example water, ethylene glycol, diethylene glycol, butyl diglycol, glycerol, diethylene glycol, trimethylolpropane, propylene glycol, pentaerythritol, sorbitol, sucrose, ethylenediamine, toluenediamine, triethanolamine, bisphenols, in particular 4,4′-methylenebisphenol, 4,4′-(1-methylethylidene)bisphenol, 1,4-butanediol, 1,6-hexanediol and low molecular weight hydroxyl-containing esters of such polyols with dicarboxylic acids and oligoethers of such polyols.

Usable polycarbonate polyols are hydroxyl-containing polycarbonates, for example polycarbonate diols. These are formed in the reaction of carbonic acid derivatives, such as diphenyl carbonate, dimethyl carbonate or phosgene, with polyols, preferably diols.

Examples of such diols are ethylene glycol, propane-1,2- and -1,3-diol, butane-1,3- and -1,4-diol, hexane-1,6-diol, octane-1,8-diol, neopentyl glycol, 1,4-bishydroxymethylcyclohexane, 2-methylpropane-1,3-diol, 2,2,4-trimethylpentane-1,3-diol, dipropylene glycol, polypropylene glycols, dibutylene glycol, polybutylene glycols, bisphenols and lactone-modified diols of the abovementioned type.

Instead of or in addition to pure polycarbonate diols, it is also possible to use polyether polycarbonate diols obtainable for example by copolymerization of alkylene oxides, such as for example propylene oxide, with CO₂.

In addition to the described polyols the polyol component B1) may also contain further isocyanate-reactive compounds B1.c), in particular polyamines, polyamino alcohols and polythiols. Of course, the isocyanate-reactive components described also comprise those compounds having mixed functionalities. In preferred embodiments of the component B1.c) said component also contains low molecular weight isocyanate-reactive compounds, in particular di- or trifunctional amines and alcohols, particularly preferably diols and/or triols having molar masses Mₙ of less than 400 g/mol, preferably of 60 to 300 g/mol. Employable compounds include for example triethanolamine, diethylene glycol, ethylene glycol, glycerol and low molecular weight esters or half esters of these alcohols, for example the half esters of phthalic anhydride and diethylene glycol. If such low molecular weight isocyanate-reactive compounds are used for producing the rigid PUR/PIR foams, for example as chain extenders and/or crosslinking agents, these are expediently employed in an amount of at most 5% by weight based on the total weight of component B1). Compounds which on account of their structure fall not only under the definition of component B1.c) but also under one of the definitions of the above-described polyol compounds B1.a) or B1.b) are counted as belonging to the component B1.a) or B1.b) and not to the component B1.c).

A preferred polyol component B1) for the foams produced by this process contains 55 to 100% by weight of the polyol component B1.a) which is selected from one or more polyols from the group consisting of polyester polyols and polyetherester polyols having hydroxyl numbers in the range between 100 to 300 mg KOH/g and functionalities of ≥1.2 to ≤3.5, in particular ≥1.6 to ≤2.4, furthermore 0% to 25% by weight, preferably 1% to 20% by weight, of long-chain polyether polyols B1.b) having a functionality of ≥1.2 to ≤3.5 and a hydroxyl number between 10 and 100 mg KOH/g and 0% to 10% by weight, in particular 0% to 5% by weight, of low molecular weight isocyanate-reactive compounds having a molar mass Mₙ of less than 400 g/mol (B1.c) and 0% to 10% by weight, in particular 0% to 6% by weight, of medium-chain polyether polyols having functionalities of ≥2 to ≤6 and a hydroxyl number between 300 and 700 mg KOH/g (B1.b) may be present.

In a further preferred embodiment the polyol component B1) contains at least one polyester polyol having a functionality of ≥1.2 to ≤3.5, in particular ≥1.8 to ≤2.5, and a hydroxyl number of 100 to 300 mg KOH/g and also an acid number of 0.0 to 5.0 mg KOH/g in an amount of 65.0-98.0% by weight based on the total weight of the component B.1); and a polyether polyol having a functionality of ≥1.8 to ≤3.5 and a hydroxyl number of 10 to 100 mg KOH/g, preferably 20 to 50 mg KOH/g, in an amount of 1.0% to 20.0% by weight based on the total weight of the component B1).

In a preferred embodiment the present invention relates to a rigid polyurethane/polyisocyanurate foam obtainable by reaction of a reaction mixture composed of

B) an isocyanate-reactive composition comprising

B1.a) 50.0% to 90.0% by weight of at least one polyester polyol and/or polyether ester polyol having a hydroxyl number in the range from 80 mg KOH/g to 290 mg KOH/g determined according to DIN 53240,

B1.b) 1.0% to 20.0% by weight of at least one polyether polyol having a hydroxyl number in the range from 300 mg KOH/g to 600 mg KOH/g determined according to DIN 53240,

B1.c) 0.0% to 5.0% by weight, in particular 1.0-5.0% by weight, of low molecular weight isocyanate-reactive compounds having a molar mass Mₙ of less than 400 g/mol

B3.b) 1.0% to 30.0% by weight of at least one flame retardant,

B2.a) 0.1% to 4.0% by weight of potassium formate,

B2.b) 0.1% to 3.0% by weight of aminic catalyst components

wherein the reported % by weight values in each case relate to all components of the isocyanate-reactive composition B),

with

A) a mixture of diphenylmethane-4,4′-diisocyanate with isomeric and higher-functional homologs, wherein the isocyanate index is ≥150 to ≤450,

in the presence of

C) a physical blowing agent,

characterized

in that the catalyst component B2.a) contains potassium formate and B2.b) an amine, selected from the group consisting of dimethylbenzylamine and dimethylcyclohexylamine, and

in that the reaction mixture contains less than 0.20% by weight of formic acid, and

and with the proviso that the reaction mixture reacted in step i) contains no aminic compounds having the formula (I).

In a particularly preferred embodiment of the reaction mixture described above, the polyether polyol B1.b) is a polyether polyol started with an aromatic amine.

The isocyanate-reactive component B) or the reaction mixture may contain auxiliary and additive substances B3). These are either initially charged with the other components or metered into the mixture of the components during production of the rigid PUR/PIR foams.

The auxiliary and additive substances B3) preferably comprise emulsifiers (B3.a). Compounds employable as suitable emulsifiers which also act as foam stabilizers include for example all commercially available silicone oligomers modified by polyether side chains which are also employed for producing conventional polyurethane foams. When emulsifiers are employed they are employed in amounts of preferably up to 8% by weight, particularly preferably 0.5% to 7.0% by weight, in each case based on the total weight of the isocyanate-reactive composition. Preferred emulsifiers are polyether polysiloxane copolymers. These are commercially available for example under the names Tegostab® B84504 and B8443 from Evonik, Niax* L-5111 from Momentive Performance Materials, AK8830 from Maystar and Struksilon 8031 from Schill and Seilacher. Silicone-free stabilizers, such as for example LK 443 from Air Products, may also be employed.

Flame retardants (B3.b) are also added to the isocyanate-reactive compositions to improve fire resistance. Such flame retardants are known in principle to the person skilled in the art and are described, for example, in “Kunststoffhandbuch”, volume 7 “Polyurethane”, chapter 6.1. These may include for example halogenated polyesters and polyols, brominated and chlorinated paraffins or phosphorus compounds, such as for example the esters of orthophosphoric acid and of metaphosphoric acid, which may likewise contain halogen. It is preferable to choose flame retardants that are liquid at room temperature. Examples include triethyl phosphate, diethylethane phosphonate, cresyldiphenyl phosphate, dimethylpropane phosphonate and tris(β-chloroisopropyl) phosphate. Flame retardants selected from the group consisting of tris(chloro-2-propyl) phosphate (TCPP) and triethyl phosphate (TEP) and mixtures thereof are particularly preferred. It is preferable to employ flame retardants in an amount of 1% to 30% by weight, particularly preferably 5% to 30% by weight, based on the total weight of the isocyanate-reactive composition B). It may also be advantageous to combine different flame retardants with one another to achieve particular profiles of properties (viscosity, brittleness, flammability, halogen content etc.). In certain embodiments the presence of triethyl phosphate (TEP) in the flame retardant mixture or as the sole flame retardant is particularly advantageous.

Furthermore, the component B3) also comprises all other additives (B3.c) that may be added to isocyanate-reactive compositions. Examples of such additives are cell regulators, thixotropic agents, plasticizers and dyes.

According to the invention the catalyst component B2) contains potassium formate B2.a). This is often employed as a solution, for example in diethylene glycol/monoethylene glycol. It is preferable to employ potassium formate in a concentration of 0.2-4.0% by weight, preferably 0.4-2.0% by weight (based on the mass of pure potassium formate in the component B). According to the invention, the catalyst component B2) furthermore contains

B2.b) an aminic catalyst, which cannot be described with the formula (I). The aminic catalyst is selected, for example, from the group consisting of amidines, such as 2,3-dimethyl-3,4,5,6-tetrahydropyrimidine, and/or tertiary amines, such as triethylamine, tributylamine, dimethylcyclohexylamine, dimethylbenzylamine, N-methyl-, N-ethyl-, N-cyclohexylmorpholine, N,N,N′,N′-tetramethylethylenediamine, N,N,N′,N′-tetramethylbutanediamine, N,N,N′,N′-tetramethylhexanediamine-1,6, pentamethyldiethylenetriamine, bis(dimethylaminopropyl)urea, dimethylpiperazine, 1,2-dimethylimidazole, N,N′,N″-tris(dimethylaminopropyl)hexahydrotriazine, 1-azabicyclo-(3,3,0)-octane and 1,4-diazabicyclo-(2,2,2)-octane, and alkanolamine compounds which are not included in formula (I), such as tris(dimethylaminomethyl)phenol, triethanolamine, triisopropanolamine, and N-ethyldiethanolamine. Particularly suitable compounds are selected from the group comprising tertiary amines, such as triethylamine, tributylamine, dimethylcyclohexylamine, dimethylbenzylamine, N,N,N′,N′-tetramethylethylenediamine, pentamethyldiethylenetriamine, dimethylpiperazine, 1,2-dimethylimidazole and alkanolamine compounds which are not included in formula (I), such as tris(dimethylaminomethyl)phenol, triethanolamine, triisopropanolamine, and N-ethyldiethanolamine.

The aminic catalyst preferably contains at least one amine of formula NR¹R²R³, wherein R¹, R² and R³ each independently of one another represent an alkyl or aryl group, preferably a methyl, ethyl, propyl, cyclohexyl, benzyl or phenyl group.

The component B2.b) preferably contains dimethylbenzylamine (DMBA, IUPAC name N,N-dimethyl-1-phenylmethanamine) and/or dimethylcyclohexylamine (DMCHA, IUPAC name N,N-dimethylcyclohexanamine), in particular dimethylcyclohexylamine. In particular the component B2.b) contains no further aminic catalysts in addition to dimethylbenzylamine and/or dimethylcyclohexylamine.

In addition to the abovementioned compounds B2.a) and B2.b), further catalysts may be present in B2) in order for example to catalyze the blowing reaction, the urethane reaction and/or the isocyanurate reaction (trimerization).

Particularly suitable in addition to the abovementioned catalyst components are in particular one or more catalytically active compounds selected from

B2.c) metal carboxylates distinct from potassium formate, in particular alkali metals or alkaline earth metals, in particular sodium acetate, sodium octoate, potassium acetate, potassium octoate, and also tin carboxylates, for example tin(II) acetate, tin(II) octoate, tin(II) ethylhexoate, tin(II) laurate, dibutyltin diacetate, dibutyltin dilaurate, dibutyltin maleate and dioctyltin diacetate and ammonium carboxylates. Sodium, potassium and ammonium carboxylates are especially preferred. Preferred carboxylates are ethylhexanoates (=octoates), propionates and acetates.

According to the invention the catalyst component contains no aminic compounds B2.d) of formula (I)

R¹N(CH₃)(CH₂CH₂OR²) (I)

wherein
R¹ represents CH₃, CH₂—CH₂—N(CH₃)₂ or CH₂—CH₂OH and
R² represents H, CH₂—CH₂OH or CH₂—CH₂N(CH₃)₂.

In particular the catalyst component and the entire reaction mixture contains none of the following compounds: bis(dimethylaminoethyl)ether, N,N,N-trimethylaminoethylethanolamine, N,N,N-trimethyl-N-hydroxyethylbis(aminoethyl)ether, N,N-dimethylaminoethoxyethanol or dimethylethanolamine. Contrary to what has been disclosed in the prior art it has surprisingly been found that the absence of these compounds has a positive effect on the surface constitution of the rigid PUR/PIR foams.

The catalyst components may be metered into the reaction mixture or else completely or partially initially charged in the isocyanate-reactive component B).

The reactivity of the reaction mixture is usually adapted to the requirements by means of the catalyst component. Production of thin panels thus requires a reaction mixture having a higher reactivity than production of thicker panels. Cream time and fiber time are respectively typical parameters for the time taken for the reaction mixture to begin to react and for the point at which a sufficiently stable polymer network has been formed. In a preferred embodiment the catalysts B2.a), B2.b) and optionally B2.c) required for producing the rigid foam are employed in an amount such that for example in continuously producing plants elements having flexible and rigid outerlayers can be produced at rates of up to 80 m/min depending on element thickness.

Preferably employed in the reaction mixture is in particular a combination of the catalyst components potassium formate B2.a) and aminic catalysts B2.b) in a molar ratio n(potassium formate)/n(amine) between 0.1 and 80, in particular between 0.5 and 20. Short fiber times may be achieved for example with more than 0.2% by weight of potassium formate based on all components of the reaction mixture.

The proportion of pure potassium formate in the catalyst mixture is preferably 15-90% by weight, particularly preferably 30-80% by weight. It is preferable when no further catalysts which catalyze the trimerization reaction are employed in addition to potassium formate. It is particularly preferable when the catalyst mixture contains no further metal carboxylates in addition to potassium formate.

The reaction mixture further contains sufficient blowing agent C) as is required for achieving a dimensionally stable foam matrix and the desired apparent density. This is generally 0.5-30.0 parts by weight of blowing agent based on 100.0 parts by weight of the component B. Preferably employed blowing agents are physical blowing agents selected from at least one member of the group consisting of hydrocarbons, halogenated ethers and perfluorinated and partially fluorinated hydrocarbons having 1 to 8 carbon atoms. In the context of the present invention “physical blowing agents” are to be understood as meaning those compounds which on account of their physical properties are volatile and unreactive toward the polyisocyanate component. The physical blowing agents to be used according to the invention are preferably selected from hydrocarbons (for example n-pentane, isopentane, cyclopentane, butane, isobutane, propane), ethers (for example methylal), halogenated ethers, (per)uorinated hydrocarbons having 1 to 8 carbon atoms (for example perfluorohexane) and mixtures thereof with one another. Also preferred is the use of (hydro)fluorinated olefins, for example HFO 1233zd(E) (trans-1-chloro-3,3,3-trifluoro-1-propene) or HFO 1336mzz(Z) (cis-1,1,1,4,4,4-hexafluoro-2-butene) or additives such as FA 188 from 3M (1,1,1,2,3,4,5,5,5-nonafluoro-4-(trifluoromethyl)pent-2-ene) and the use of combinations of these blowing agents. In particularly preferred embodiments the blowing agent C) employed is a pentane isomer or a mixture of different pentane isomers. It is exceptionally preferable to employ a mixture of cyclopentane and isopentane as the blowing agent C). Further examples of preferably employed hydrofluorocarbons are for example HFC 245fa (1,1,1,3,3-pentafluoropropane), HFC 365mfc (1,1,1,3,3-pentafluorobutane), HFC 134a or mixtures thereof. Different blowing agent classes may also be combined.

Also especially preferred is the use of (hydro)fluorinated olefins, for example HFO 1233zd(E) (trans-1-chloro-3,3,3-trifluoro-1-propene) or HFO 1336mzz(Z) (cis-1,1,1,4,4,4-hexafluoro-2-butene) or additives such as FA 188 from 3M (1,1,1,2,3,4,5,5,5-nonafluoro-4(or 2)-(trifluoromethyl)pent-2-ene and/or 1,1,1,3,4,4,5,5,5-nonafluoro-4(or 2)-(trifluoromethyl)pent-2-ene), alone or in combination with other blowing agents. These have the advantage of having a particularly low ozone depletion potential (ODP) and a particularly low global warming potential (GWP).

According to the invention the reaction mixture has the feature that it contains less than 0.20% by weight, preferably less than 0.10% by weight, of formic acid and especially preferably no formic acid. Chemical blowing agents D) may be present in each case with the proviso that less than 0.20% by weight, preferably less than 0.10% by weight, of formic acid, especially preferably no formic acid, are present.

In one embodiment the reaction mixture contains the chemical blowing agent water. In a preferred embodiment the reaction mixture contains >0.30% by weight, in particular ≥0.35% by weight, of water.

In a further preferred embodiment the reaction mixture contains a carbamate which may eliminate carbon dioxide under reaction conditions in addition to the abovementioned physical blowing agents. The use of 2-hydroxypropyl carbamate for example is preferred. It has surprisingly been found that the positive effect both on foam pressure and on curing is particularly pronounced in the presence of carbamate.

The component A) is a polyisocyanate, i.e. an isocyanate having an NCO functionality of ≥2. Examples of such suitable polyisocyanates include 1,4-butylene diisocyanate, 1,5-pentane diisocyanate, 1,6-hexamethylene diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes or their mixtures of any desired isomer content, 1,4-cyclohexylene diisocyanate, 1,4-phenylene diisocyanate, 2,4- and/or 2,6-tolylene diisocyanate (TDI), 1,5-naphthylene diisocyanate, 2,2′- and/or 2,4′- and/or 4,4′-diphenylmethane diisocyanate (MDI) and/or higher homologs, 1,3- and/or 1,4-bis(2-isocyanatoprop-2-yl)benzene (TMXDI), 1,3-bis(isocyanatomethyl)benzene (XDI) and also alkyl 2,6-diisocyanatohexanoates (lysine diisocyanates) having C1 to C6-alkyl groups.

Preferably employed as the polyisocyanate component A) are mixtures of the isomers of diphenylmethane diisocyanate (“monomeric MDI”, “mMDI” for short) and oligomers thereof (“oligomeric MDI”). Mixtures of monomeric MDI and oligomeric MDI are generally described as “polymeric MDI” (pMDI). The oligomers of MDI are higher-nuclear polyphenylpolymethylene polyisocyanates, i.e. mixtures of the higher-nuclear homologs of diphenylmethylene diisocyanate which have an NCO functionality f>2 and may be described by the following empirical formula: C₁₅H₁₀N₂O₂[C₈H₅NO]ₙ, wherein n=integer>0, preferably n=1, 2, 3 and 4. Higher-nuclear homologs C₁₅H₁₀N₂O₂[C₈H₅NO]ₘ, m=integer≥4) may likewise be present in the mixture of organic polyisocyanates A). Further preferred as polyisocyanate component A) are mixtures of mMDI and/or pMDI comprising at most up to 20% by weight, more preferably at most 10% by weight, of further aliphatic, cycloaliphatic and especially aromatic polyisocyanates known for the production of polyurethanes, very particularly TDI.

The polyisocyanate component A) moreover has the feature that it preferably has a functionality of at least 2, in particular at least 2.2, particularly preferably at least 2.4 and very particularly preferably at least 2.7.

For use as the polyisocyanate component polymeric MDI types are particularly preferred over monomeric isocyanates in rigid foam.

The NCO content of the polyisocyanate component A) is preferably from ≥29.0% by weight to ≤33.0% by weight and preferably has a viscosity at 25° C. of ≥80 mPas to ≤2900 mPas, particularly preferably of ≥95 mPas to ≤850 mPas at 25° C.

The NCO value (also known as NCO content, isocyanate content) is determined according to EN ISO 11909:2007. Unless otherwise stated values at 25° C. are concerned.

Reported viscosities are dynamic viscosities determined according to DIN EN ISO 3219:1994-10 “Plastics—Polymers/Resins in the liquid State or as Emulsions or Dispersions”.

In addition to the abovementioned polyisocyanates, it is also possible to co-use proportions of modified diisocyanates having a uretdione, isocyanurate, urethane, carbodiimide, uretonimine, allophanate, biuret, amide, iminooxadiazinedione and/or oxadiazinetrione structure and also unmodified polyisocyanate having more than 2 NCO groups per molecule, for example 4-isocyanatomethyl-1,8-octane diisocyanate (nonane triisocyanate) or triphenylmethane 4,4′,4″-triisocyanate.

Also employable as the organic polyisocyanate component A) instead of or in addition to the abovementioned polyisocyanates are suitable NCO prepolymers. The prepolymers are producible by reaction of one or more polyisocyanates with one or more polyols according to the polyols described under the components A). The isocyanate may be a prepolymer obtainable by reaction of an isocyanate having an NCO functionality of ≥2 and polyols having a molar mass Mn of ≥62 g/mol to □8000 g/mol and OH functionalities of ≥1.5 to □6.0.

Isocyanate-reactive component B) and polyisocyanate component A) are mixed to produce a reaction mixture which results in the rigid PUR/PIR foam. Production is generally carried out by mixing of all components via customary high- or low-pressure mixing heads.

The isocyanate index (also called index) is to be understood as meaning the quotient of the molar amount [mol] of isocyanate groups actually used and the molar amount [mol] of isocyanate-reactive groups actually used, multiplied by 100:

index=(moles of isocyanate groups/moles of isocyanate-reactive groups)*100

In the reaction mixture the number of NCO groups in the isocyanate and the number of isocyanate-reactive groups are adjusted such that they result in an index of 150 to 600. The index is preferably in a range from >180 to <450.

In one embodiment of the polyurethane/polyisocyanurate foams according to the invention said foams have an apparent core density of ≥30 kg/m³ to ≤50 kg/m³. The density is determined according to DIN EN ISO 3386-1-98. The density is preferably in a range from ≥33 kg/m³ to ≤45 kg/m³ and particularly preferably from ≥36 kg/m³ to ≤42 kg/m³.

The present invention further provides for the use of the PUR/PIR foams according to the invention for production of composite elements, in particular metal composite elements. In order to avoid unnecessary repetition, reference is made to the elucidations of the process according to the invention for details of individual embodiments.

Metal composite elements are sandwich composite elements consisting of at least two outerlayers and a core layer arranged therebetween. In particular, metal-foam composite elements consist at least of two outerlayers made of metal and a core layer made of a foam, for example a rigid polyurethane (PUR) foam or of a rigid polyurethane/polyisocyanurate (PUR/PIR) foam. These metal-foam composite elements are well known from the prior art and are also referred to as metal composite elements. Outerlayers employed include not only coated steel sheets but also stainless steel, copper or aluminum sheets. Further layers may be provided between the core layer and the outerlayers. The outerlayers may for example be coated, for example with a lacquer.

Examples of the use of these metal composite elements are flat wall elements or wall elements having linear features, and also profiled roof elements for construction of industrial buildings and of cold stores, and also for truck bodies, industrial doors or transport containers.

The production of these metal composite elements may be carried out continuously (preferred) or discontinuously. Apparatuses for continuous production are known for example from DE 1 609 668 A or DE 1 247 612 A. One continuous application involves the use of double belt plants. In the prior art double belt process, the reaction mixture is applied to the lower outerlayer for example using oscillating applicators, for example applicator rakes, or one or more fixed applicators, for example using applicator rakes comprising holes or other bores or using nozzles comprising slots and/or slits or using multi-prong technology. See in this regard for example EP 2 216 156 A1, WO 2013/107742 A, WO 2013/107739 A and WO 2017/021463 A.

In addition, the invention also relates to a process for producing a composite element, wherein a reaction mixture according to the invention is applied to a moving outerlayer using a curtain coater.

### EXAMPLES

The following compounds are employed for production of the rigid foams:
B1.a-P1 Aliphatic polyester polyol produced by reacting a mixture of adipic acid, succinic acid and glutaric acid with ethylene glycol, OH number 216 mg KOH/g, from Covestro Deutschland AG
B1.a-P2 Stepanpol PS 2412, aromatic polyester polyol based on phthalic anhydride and diethylene glycol, containing 3-10% by weight of TCPP, OH number 240 mg KOH/g, from Stepan
B1.b-P3 Polyether polyol based on propylene glycol, propylene oxide and ethylene oxide having 90% primary OH groups and an OH number of 28 mg KOH/g, from Covestro Deutschland AG.
B1.b-P4 Polyether polyol based on ethylene glycol, saccharose and propylene oxide having an OH number of 440 mg KOH/g, from Covestro Deutschland AG.
B1.b-P5 Polyether polyol based on saccharose, propylene glycol, ethylene glycol and propylene oxide having an OH number of 380 mg KOH/g, from Covestro Deutschland AG.
B1.b-P6 Polyether polyol based on ethylenediamine and propylene oxide having an OH number of 620 mg KOH/g, from Covestro Deutschland AG.
B3.b-1 Tris(1-chloro-2-propyl) phosphate from Lanxess GmbH (component B3.b)
B3.b-2 Triethyl phosphate from Lanxess GmbH
B3.a-1 Polyether polysiloxane copolymer Tegostab® B8443 from Evonik
B1-P7 Castor oil
A-1 Desmodur® 44V70L polymeric polyisocyanate based on 4,4-diphenylmethane diisocyanate having an NCO content of about 31.5% by weight from Covestro Deutschland AG
B2.c-1 Potassium acetate (potassium ethanoate IUPAC name), 25% by weight in diethylene glycol
B2.a-1 Potassium formate (potassium methanoate IUPAC name), 36% by weight in monoethylene glycol
B2.b-1 Dimethylbenzylamine (N,N-dimethyl-1-phenylmethanamine IUPAC name)
B2.b-2 Dimethylcyclohexylamine (N,N-dimethylcyclohexanamine IUPAC name)
B2.d-1 Bis(2-dimethylaminoethyl)ether (Niax® A1, 70% in dipropylene glycol, Momentive Performance Materials) (aminic compound having structural formula of formula (I))
B2.d-2 2,T-dimorpholinyl diethyl ether (DMDEE aminic compound having structural formula of formula (I))
C-1 n-Pentane [F+;Xn;N]
D-1 Water

Measurement of reaction and product properties of produced rigid PUR/PIR foams:

The foam pressure and the flow properties during the foaming reaction may be determined in a rigid foam tube by processes known to those skilled in the art. To this end the reaction mixture is produced in a paper cup as per the description hereinabove and the filled paper cup is introduced from below into a temperature-controlled tube. The rise profile and the exerted foam pressure are continuously captured during the reaction.

Measurement of apparent density was performed according to DIN EN ISO 845 (October 2009).

Measuring fiber time:

The fiber time is generally the time after which for example in the polyaddition between polyol and polyisocyanate a theoretically infinitely extended polymer has formed (transition from the liquid into the solid state). The fiber time may be determined experimentally by dipping a thin wooden stick into the foaming reaction mixture, produced here in a test package having a base area of 20×20 cm², at short intervals. The time from the mixing of the components until the time at which threads remain hanging off the rod when removed is the fiber time.

Measurement of tack-free time:

Once dispensing was complete the tack-free time of the foam surface was determined according to TM 1014:2013 (FEICA).

Measurement of impression depth:

The impression depth was determined on freshly produced laboratory foams in test packages having a base area of 20×20 cm² by measurement of the penetration depth of a piston with a defined piston pressure after the reported times during the curing phase.

### Examples 1-12

### Production of Pentane-Blown Foams

All foams are produced by hand mixing on the laboratory scale in test packages having a base area of 20×20 cm² (for formulations and reaction properties see table 1 and table 3). The polyol component containing the polyols, additives and catalysts are initially charged. Shortly before mixing, the polyol component is temperature-controlled to 23-25° C., whereas the polyisocyanate component is brought to a constant temperature of 30-35° C. Subsequently, with stirring, the polyisocyanate component is added to the polyol mixture, to which the amount of pentane necessary to achieve an apparent core density of 37-38 kg/m³ has previously been added. The mixing time is 6 seconds and the mixing speed of the Pendraulik stirrer is 4200 min−1. After 2.5 or 5 minutes the foam hardness is determined using an indentation method and after 8-10 minutes the maximum core temperature is determined. The foam is then stored for a further 24 hours 20 at 23° C. to allow postreaction.

TABLE 1
Formulation of rigid PUR/PIR foams

| | | Example | Example | Example | Example | Example | Example | Example | Example | Example | Example |
|---|---|---|---|---|---|---|---|---|---|---|---|
| | | 1* | 2 | 3 | 4* | 5* | 6* | 7* | 8 | 9* | 10 |
| B1.a-P1 | pbw | 73 | 73 | 73 | 73 | 73 | 73 | | | 83 | 83 |
| B1.a-P2 | | | | | | | | 83 | 83 | | |
| B1.b-P3 | pbw | 12 | 12 | 12 | 12 | 12 | 12 | 5 | 5 | 5 | 5 |
| B3.b-1 | pbw | 15 | 15 | 15 | 15 | 15 | 15 | | | | |
| B3.b-2 | | | | | | | | 10.5 | 10.5 | 10.5 | 10.5 |
| D-1 | pbw | 0.80 | 0.80 | 0.80 | 0.80 | 0.80 | 0.80 | 0.50 | 0.50 | 0.50 | 0.50 |
| B3.a-1 | pbw | 3.00 | 3.00 | 3.00 | 3.00 | 3.00 | 3.00 | 3.00 | 3.00 | 3.00 | 3.00 |
| B2.b-1 | pbw | 1.20 | 1.20 | | | | | 1.50 | 1.20 | 1.50 | 1.20 |
| B2.c-1 | pbw | 3.50 | | | | | 3.50 | 3.00 | | 3.00 | |
| B2.b-2 | pbw | | | 0.30 | | | 0.30 | | | | |
| B2.a-1 | pbw | | 2.30 | 2.30 | 2.30 | 2.30 | | | 2.00 | | 2.10 |
| B2.d-1 | pbw | | | | | 0.40 | | | | | |
| B2.d-2 | pbw | | | | 3.60 | | | | | | |
| C-1 | pbw | 13.30 | 12.30 | 12.20 | 12.40 | 12.30 | 13.20 | 13.20 | 12.80 | 13.20 | 12.80 |
| C-1 | wt-% | 4.10 | 3.80 | 3.80 | 3.80 | 3.80 | 4.10 | 4.10 | 4.00 | 4.10 | 4.00 |
| A-1 | pbw | 202.75 | 201.87 | 201.87 | 201.87 | 202.72 | 202.75 | 200.00 | 200.00 | 200.00 | 200.00 |
| Index | | 350.0 | 350.0 | 350.0 | 350.0 | 350.0 | 350.0 | 311.6 | 312.3 | 337.0 | 336.13 |

TABLE 2
Reaction and product properties of produced rigid PUR/PIR foams

| | | Example | Example | Example | Example | Example | Example | Example | Example | Example | Example |
|---|---|---|---|---|---|---|---|---|---|---|---|
| | | 1* | 2 | 3 | 4* | 5* | 6* | 7* | 8 | 9* | 10 |
| Cream time | s | 13 | 13 | 14 | 9 | 9 | 13 | 13 | 12 | 14 | 13 |
| Fiber time | s | 38 | 38 | 37 | 39 | 38 | 36 | 39 | 38 | 39 | 38 |
| Tack-free time | s | 43 | 45 | 42 | 45 | 45 | 42 | 49 | 49 | 48 | 45 |
| Apparent core density | kg/m3 | 40.2 | 40.7 | 40.8 | 41 | 39.8 | 41.2 | 39.7 | 37.9 | 38.6 | 37.9 |
| Water absorption | g | 9.3 | 9.2 | 8.7 | 10.8 | 10.6 | 8.7 | 10.8 | 11.1 | 8.6 | 10.9 |
| (486 cm³ foam) | | | | | | | | | | | |
| Foam pressure | hPa | 282 | 328 | 345 | 353 | 338 | 316 | 214 | 321 | 279 | 357 |
| Surface defects | | 1-2 | 1-2 | 1-2 | 4 | 4 | 1-2 | | | | |
| (flip-top mold) | | | | | | | | | | | |
| Impression depth | | | | | | | | 8.0 | 5.0 | 8.5 | 4.0 |
| after 2.5 min | | | | | | | | | | | |
| Impression depth | | | | fiqs | | | | 9.0 | 5.5 | 9.5 | 4.5 |
| after 5 min | | | | | | | | | | | |
| Fire class | | E | E | E | E | E | E | E | E | E | E |
| SBT (ISO 11925-2) | | | | | | | | | | | |
| Average flame height | mm | 115 | 113 | 102 | 112 | 105 | 108 | 132 | 120 | 128 | 100 |
| Min-max flame height | mm | 110-120 | 110-115 | 100-105 | 110-115 | 100-110 | 105-115 | 130-135 | 120-120 | 125-130 | 100-100 |

It is apparent that when using potassium formate less of the physical blowing agent pentane is required to achieve a target apparent density of 40-41 kg/m³. Furthermore, all examples containing potassium formate as PIR catalyst feature higher foam pressures. This is even more pronounced when using dimethyl cyclohexylamine (DMCHA) as the aminic catalyst than when using dimethylbenzylamine (DMBA).

However, marked surface defects in the finished foam are observed when the polyol formulation contains a diaminoether (Niax, DMDEE) as in comparative examples 4* and 5*.

In addition, the foams produced with potassium formate exhibit improved curing (quantified by the impression depth of a weight after 2.5 and 5 min) compared to the foams catalyzed with potassium acetate (comparative example 7* vs 8, comparative example 9* vs 10).

Surprisingly, improved fire characteristics in the small burner test (SBT) compared to the potassium acetate-catalyzed foams are observed even in the case of foams which contain the halogen-free flame retardant TEP and potassium formate. This is all the more surprising since in the foams protected with the flame retardant TCPP this effect was only observable—and even then less pronounced—for the combination of potassium formate and dimethylcyclohexylamine.

Substitution of B1.a-P2 (aromatic polyester polyol) for B1.a-P1 (aliphatic polyester polyol) (example 8 vs example 10) likewise brings marked advantages in respect of foam pressures, impression depth and fire characteristics.

However, the use of potassium formate in rigid polyurethane foams having an index of 120 does not show the same positive effect as in PUR/PIR foams (comparative examples 11 and 12, table 3). For identical employed pentane amounts polyurethane foams catalyzed with potassium formate instead of potassium acetate exhibit virtually identical foam pressure and identical apparent densities as well as only small differences in curing.

TABLE 3
Formulation and properties of rigid
polyurethane foams (noninventive)

| | | Example | Example |
|---|---|---|---|
| | | 11* | 12* |
| B1.b-P4 | pbw | 40.00 | 40.00 |
| B1.b-P5 | pbw | 23.50 | 23.50 |
| B1.b-P6 | pbw | 9.90 | 9.90 |
| B1-P7 | pbw | 15.50 | 15.50 |
| B3.b-1 | | 6.10 | 6.10 |
| D-1 | pbw | 1.80 | 1.80 |
| B3.a-1 | pbw | 3.20 | 3.20 |
| B2.b-2 | pbw | 2.13 | 2.14 |
| B2.C-1 | pbw | 2.02 | |
| B2.a-1 | pbw | | 1.17 |
| C-1 | pbw | 5.32 | 5.34 |
| C-1 | wt-% | 2.01 | 2.02 |
| A-1 | pbw | 149.06 | 149.54 |
| Index | | 119.3 | 119.8 |
| Cream time | s | 13 | 13 |
| Fiber time | s | 46 | 47 |
| Tack-free time | s | 43 | 45 |
| Apparent core density | kg/m | 62 | 64 |
| Foam pressure | hPa | 256 | 267 |
| Impression depth after 2.5 | | 8.3 | 7.6 |
| min | | | |
| Impression depth after 5 min | | 9.2 | 8.4 |

1. A process for producing a rigid polyurethane/polyisocyanurate (PUR/PIR) foam comprising reacting a reaction mixture comprising:
A) a polyisocyanate component, and
B) an isocyanate-reactive component comprising:
B1) a polyol component,
B2) a catalyst component, and
B3) optionally auxiliary and additive substances; and
C) a physical blowing agent
wherein:
(1) the catalyst component B2) comprises potassium formate B2.a) and an amine B2.b), and
(2) the reaction mixture contains less than 0.2% by weight of formic acid and has an isocyanate index ≥150,
the proviso that the reaction mixture contains no aminic compounds having the formula (I)
R¹N(CH₃)(CH₂CH₂OR²) (I)
wherein
R¹ represents CH₃, CH₂—CH₂—N(CH₃)₂ or CH₂—CH₂OH, and
R² represents H, CH₂—CH₂OH or CH₂—CH₂N(CH₃)₂.

2. The process as claimed in claim 1, wherein the reaction mixture further contains less than 0.20% by weight of naphthenic acids.

3. The process as claimed in claim 1, wherein the isocyanate-reactive component B) comprises
B1.a) at least one polyester polyol, at least one polyether ester polyol, or a combination thereof.

4. The process as claimed in claim 2, wherein the at least one polyester polyol, at least one polyether ester polyol, or a combination thereof is present in an amount of at least 55% by weight, based on the total weight of the isocyanate-reactive component.

5. The process as claimed in claim 1, wherein the component B2.b) comprises dimethylbenzylamine or dimethylcyclohexylamine.

6. The process as claimed in claim 1 the potassium formate B2.a) is present in an amount of 0.2% to 4.0% by weight, based on the total weight of component B).

7. The process as claimed in claim 1, wherein the amine B2.b) is present in an amount of 0.1% to 3.0% by weight, based on the total weight of component B).

8. The process as claimed in claim 1, wherein the potassium formate is present in an amount of 15.0% to 90.0% by weight of potassium formate and the amine is present in an amount of 10.0% to 85.0% by weight, each based on the total weight of the catalyst component B2).

9. The process as claimed in claim 1, wherein the blowing agent C) comprises a physical blowing agent comprising one or more of a hydrocarbon, a halogenated ether and a (per)fluorinated hydrocarbons.

10. The process as claimed in claim 1, wherein the reaction mixture further comprises water.

11. The process as claimed in claim 1, wherein component B) comprises:
50.0% to 90.0% by weight of at least one polyester polyol and/or polyether ester polyol B1.a) having a hydroxyl number in the range from 80 mg KOH/g to 290 mg KOH/g determined according to DIN 53240,
1.0% to 20.0% by weight of at least one polyether polyol B1.b) having a hydroxyl number in the range from 300 mg KOH/g to 600 mg KOH/g determined according to DIN 53240,
0.0% to 5.0% by weight of low molecular weight isocyanate-reactive compounds B1.c) having a molar mass Mₙ of less than 400 g/mol,
1.0% to 30.0% by weight of at least one flame retardant B.3),
0.1% to 4.0% by weight of potassium formate B.2a), and
0.1% to 3.0% by weight of amine B2.b)
wherein the reported % by weight values are in each case based on all components of the isocyanate-reactive composition B),
wherein component A) comprises a mixture of diphenylmethane-4,4′-diisocyanate with its isomers and higher-functional homologs and wherein the reaction mixture has an isocyanate index of ≥150 to ≤450.

12. The process as claimed in claim 1, wherein the reaction mixture comprises tris(chloro-2-propyl) phosphate (TCPP), triethyl phosphate (TEP) and mixturcsor a mixture thereof.

13. The process as claimed in claim 1, further comprising applying the reaction mixture onto a moving outerlayer using a curtain coater.

14. A rigid polyurethane/polyisocyanurate foam obtained by the process as claimed in claim 1.

15. A composite element comprising one or two outerlayers and a rigid polyurethane/polyisocyanurate foam as claimed in claim 13.

16. The composite element as claimed in claim 14, wherein at least one outerlayer is made of metal.

17. A wall element, profiled roof element, industrial door or transport container comprising the composite element of claim 16.
